(19) United States
(12) Patent Application Publication
(10) Pub. No.: US 2012/0013237 A1
(43) Pub. Date: Jan. 19, 2012

(54) HEAT-DISSIPATING STRUCTURE OF LED BULB

(76) Inventor: Wen-Jen Lee, Sunchung City (TW)

(21) Appl. No.: 12/836,080

(22) Filed: Jul. 14, 2010

(51) Int. Cl. H01J 61/52

(52) U.S. Cl. 313/46

(57) ABSTRACT

A heat-dissipating structure of a LED bulb includes: a base, a heat-absorbing member, a heat-dissipating member, an assembling portion and a heat-conducting member. The base has a trough and a first hole in communication with the trough. The heat-absorbing member is provided in the trough and having a second hole in communication with the first hole. The heat-dissipating member has a third hole opposite to the first hole and a first heat-diffusing portion extending outwardly from the third hole. The first heat-diffusing portion and the base define a first heat-dissipating space there between. The assembling portion has a fourth hole and a second heat-diffusing portion extending outwardly from the fourth hole. The assembling portion and the heat-dissipating member define a second heat-dissipating space there between. A connecting end protrudes from an outer end of the second heat-diffusing portion away from the base. The heat-conducting member is disposed through the first, second, third and fourth holes to be combined with the base, the heat-absorbing member, the heat-dissipating member and the assembling portion, thereby obtaining the heat-dissipating structure having an excellent heat-dissipating effect.

### BACKGROUND OF THE INVENTION

1. Field of the Invention

The present invention relates to a LED bulb, and in particular to a heat-dissipating structure of a LED bulb, which is capable of improving the light-emitting efficiency of a LED module thereof and having an excellent heat-dissipating effect.

2. Description of Prior Art

Since the global warming is getting more and more serious, people pay more attention to environmental-friendly products conforming to the requirements for “Energy Saving & Carbon Reduction”. With regard to bulbs, traditional incandescent bulbs have been widely used in our daily life. However, almost 90% of the electricity consumed by the incandescent bulb is converted into heat energy, and only 10% of the electricity is used for illumination. Thus, the light-emitting efficiency of the incandescent bulb is so low that a large amount of electricity is wasted.

In view of the low light-emitting efficiency of the incandescent bulb, various light-emitting units are developed in the market to replace the incandescent bulb. Among all of the light-emitting units, light-emitting diode (referred to as “LED” hereinafter) can generate a higher brightness with less consumption of electricity. Further, the LED conforms to the requirements for environmental protection with a long lifetime. On the other hand, the amount of carbon dioxide generated during the production of the LED is reduced. Thus, the total cost of the LED is reduced and the pollution to the environment is abated.

Please refer to FIGS. 1A, 1B and 1C, which show a conventional LED bulb. The LED bulb includes a shroud 10, a LED module 11, a base 12, a control circuit 13, a supporting member 14 and a casing 15. The base 12 is provided with a trough 121 in which the LED module 11 is received. The shroud 10 covers the trough 121 and is fixedly combined with the base 12. The casing 15 has an accommodating space 151 in which the supporting member 14 and the base 12 are sequentially disposed in such a manner that the outer surfaces of base 14 and the supporting member 14 abut against the inner surface of the casing 15. The accommodating space 151 has a first opening 153 and a second opening 154 opposite to the first opening 153. The first opening 153 and the second opening 154 define the accommodating space 151.

The supporting piece 14 has a receiving space 151 in which the control circuit 13 is received and an electric connector 143 extending in a direction opposite to the receiving space 141. The electrical connector 143 moves toward the first opening 151 until it protrudes from the second opening 154, whereby the supporting member 14 can be fixed in the accommodating space 151. Finally, the electrical connector 143 is fixed to a lamp base of a corresponding lamp (not shown) by screws.

Therefore, when the LED module 11 emits light, the LED module 11 and a plurality of LED chips 111 inside the LED module will generate a great amount of heat. The heat will be accumulated in the trough 121 and the shroud 10 without dissipating to the outside. As a result, the light-emitting efficiency of the LED module 11 is deteriorated and the LED chips 111 within the LED module 11 may suffer damage or shorten their lifetime. More seriously, the LED module 11 and internal circuit boards may be burned down.

According to the above, the conventional LED module has the following drawbacks of: (1) poor heat-dissipating efficiency; (2) shorter life; and (3) inferior light-emitting efficiency.

Therefore, it is an important issue for the present Inventor and the manufacturers in this art to solve the problems in prior art.

### SUMMARY OF THE INVENTION

In order to solve the above problems, an objective of the present invention is to provide a heat-dissipating structure of a LED bulb, which has an excellent heat-dissipating effect.

Another objective of the present invention is to provide a heat-dissipating structure of a LED bulb, in which the lifetime of a LED module thereof is extended.

A further objective of the present invention is to provide a heat-dissipating structure of a LED bulb, in which the light-emitting efficiency of the LED module is improved.

A still further objective of the present invention is to provide a heat-dissipating structure of a LED bulb having an increased heat-dissipating area.

In order to achieve the above objectives, the present invention provides a heat-dissipating structure of a LED bulb, which includes: a base having a trough and a first hole in communication with the trough; a heat-absorbing member provided in the trough and having a second hole in communication with the first hole; a heat-dissipating member having a third hole opposite to the first hole and a first heat-diffusing portion extending outwardly from the third hole, the first heat-diffusing portion and the base defining a first heat-dissipating space there between; an assembling portion having a fourth hole opposite to the third hole and a second heat-diffusing portion extending outwardly from the fourth hole, the second heat-diffusing portion and the heat-dissipating member defining a second heat-dissipating space there between, a connecting end protruding from an outer end of the second heat-diffusing portion away from the base; and a heat-conducting member disposed through the first, second, third and fourth holes and connected with the base, the heat-absorbing member, the heat-dissipating member and the assembling portion. With the base, the heat-absorbing member, the heat-dissipating member, the assembling portion and the heat-conducting member being assembled together to form one body, the light-emitting efficiency of the LED module is improved greatly and the LED module has an excellent heat-dissipating effect.

The present invention further provides a heat-dissipating structure of a LED bulb, which includes: a base having a trough and a first hole in communication with the trough; a heat-absorbing member provided in the trough and having a second hole in communication with the first hole; a heat-dissipating member combined with a heat-conducting member, the heat-dissipating member having a first heat-diffusing portion extending outwardly from the center of the heat-conducting member, the first heat-diffusing portion and the base defining a first heat-dissipating space there between; an assembling portion having a third hole, a second heat-diffusing portion and a connecting end extending outwardly from the second heat-diffusing portion away from the base, the second heat-diffusing portion extending outwardly from the third hole, the second heat-diffusing portion and the heat-dissipating member defining a second heat-dissipating space there between, one end and another end of the heat-conducting member being disposed through the first, second and third holes to be combined with the assembling portion, the base and the heat-absorbing member. With this arrangement, the heat-dissipating structure can be obtained, whereby the light-emitting efficiency of the LED module can be improved greatly and a better heat-dissipating effect can be achieved.

The present invention further provides a heat-dissipating structure of a LED bulb, which includes: a base having a trough and a first hole in communication with the trough; a heat-absorbing member provided in the trough and having a second hole and a heat-conducting portion extending axially from an edge of the second hole; a heat-dissipating member having a third hole opposite to the first hole and a first heat-diffusing portion extending outwardly from the third hole, the first heat-diffusing portion and the base defining a first heat-dissipating space there between; and an assembling portion having a fourth hole and a second heat-diffusing portion extending outwardly from the fourth hole, the second heat-diffusing portion and the heat-dissipating member defining a second heat-dissipating space there between, a connecting end protruding from an outer end of the second heat-diffusing portion away from the base, one end of the heat-conducting portion being disposed through the first, third and fourth holes to be combined with the base, the heat-dissipating member and the assembling portion. With this arrangement, the heat-dissipating structure can be obtained, whereby the light-emitting efficiency of the LED module can be improved greatly and a better heat-dissipating effect can be achieved.

### BRIEF DESCRIPTION OF THE DRAWINGS

FIG. 1A is an assembled perspective view of a conventional LED bulb;

FIG. 1B is an exploded perspective view of the conventional LED bulb;

FIG. 1C is an assembled cross-sectional view of the conventional LED bulb;

FIG. 2 is an assembled perspective view showing a heat-dissipating structure according to first and second embodiments of the present invention;

FIG. 2A is an exploded perspective view showing the heat-dissipating structure according to the first embodiment of the present invention;

FIG. 2B is an exploded perspective view showing the heat-dissipating structure according to the second embodiment of the present invention;

FIG. 3 is an assembled perspective view showing the first, second and third embodiments of the present invention;

FIG. 4A is a front view showing the first, second and third embodiments of the present invention;

FIG. 4B is an assembled cross-sectional view of the first embodiment of the present invention;

FIG. 4C is an assembled cross-sectional view of the second embodiment of the present invention;

FIG. 5 is an exploded view of the first and second embodiments of the present invention;

FIG. 6A is an assembled perspective view showing the heat-dissipating structure according to the third embodiment of the present invention;

FIG. 6B is an exploded perspective view showing the heat-dissipating structure according to the third embodiment of the present invention;

FIG. 7 is an assembled cross-sectional view of the third embodiment of the present invention; and

FIG. 8 is an exploded view of the third embodiment of the present invention.

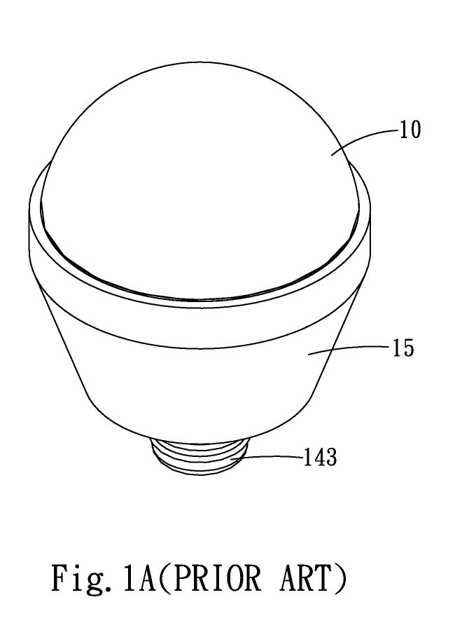

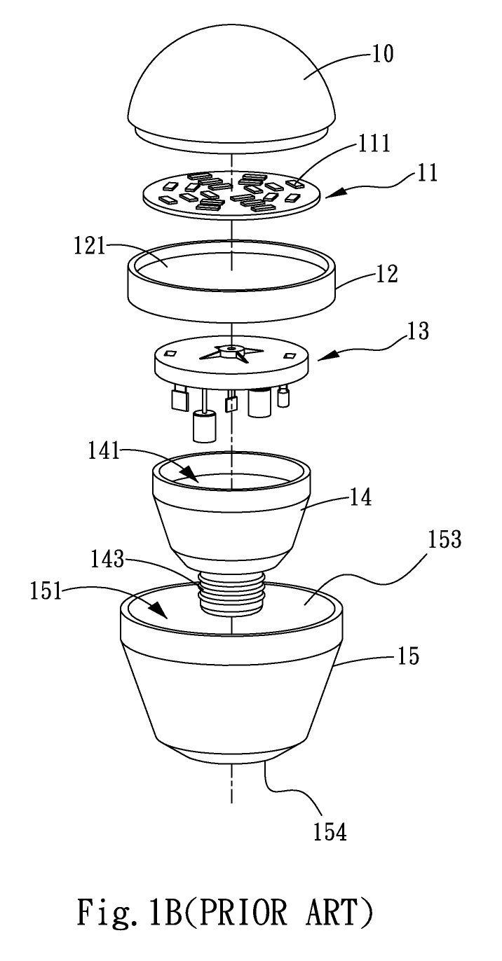

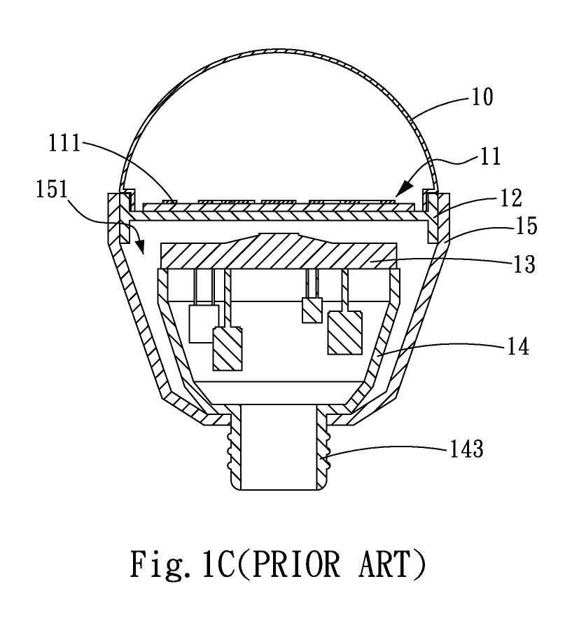

### DETAILED DESCRIPTION OF THE INVENTION

The above-mentioned objectives, structural and functional features of the present invention will be described with reference to preferred embodiments thereof and the accompanying drawings.

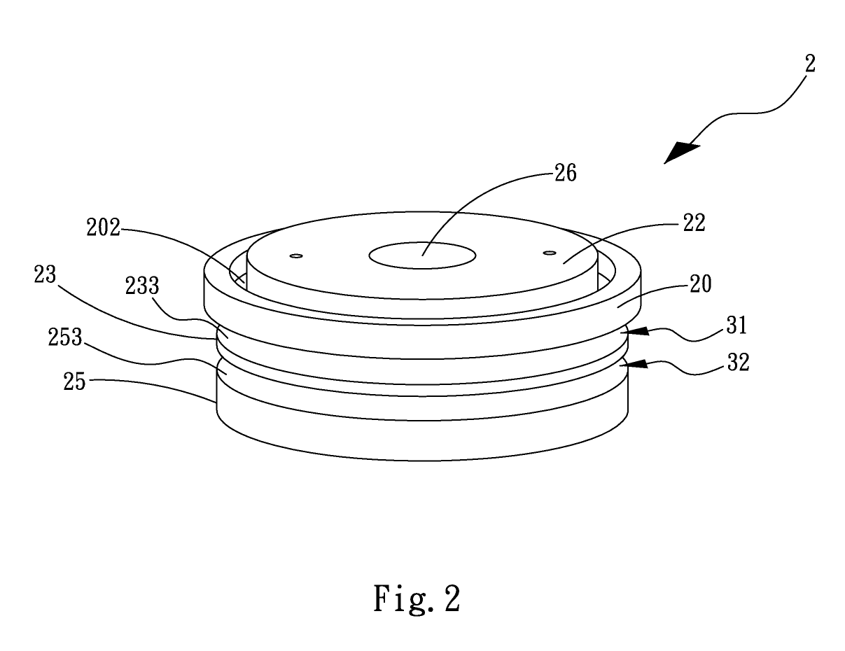

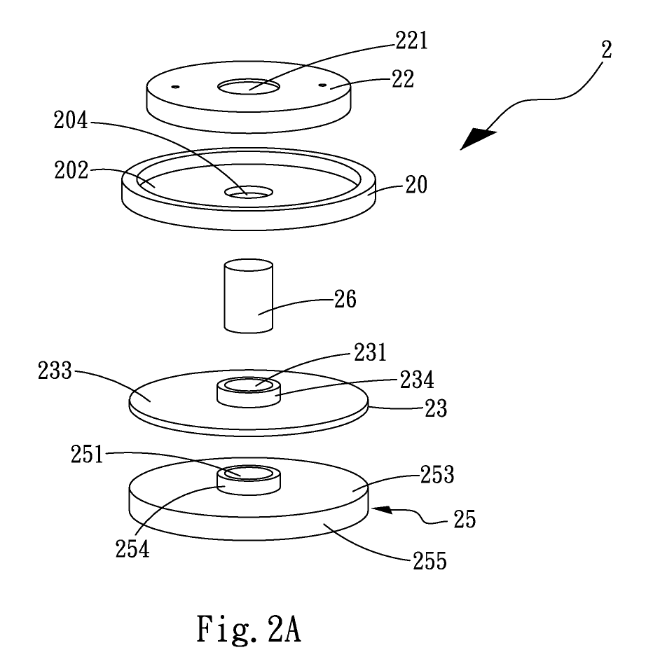

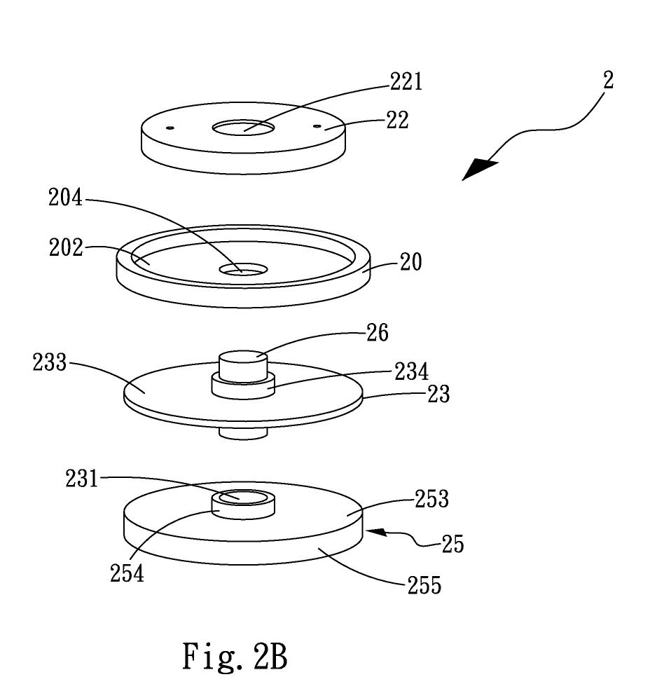

Please refer to FIGS. 2 and 2A. The present invention is directed to a heat-dissipating structure of a LED bulb. According to the first embodiment of the present invention, the heat-dissipating structure 2 includes a base 20, a heat-dissipating member 22, a heat-dissipating member 23, an assembling portion 25 and a heat-conducting member 26. The base 20 has a trough 202 for accommodating the heat-absorbing member 22. The trough 202 is provided with a first hole 204. The first hole 204 is formed in the center of the trough 202 in communication with the trough 202. The heat-absorbing member 22 is provided in the trough 202 and has a second hole 221 in communication with the first hole 204. The heat-dissipating structure 2 is made of metallic materials such as copper, iron, aluminum or the like.

The heat-dissipating member 23 has a third hole 231, a first heat-diffusing portion 233 and a first heat-conducting portion 234. The third hole 231 is located opposite to the first hole 204. The first heat-diffusing portion 233 is formed by extending outwardly from the third hole 231. The first heat-diffusing portion 233 and the base 20 define a first heat-dissipating space 31 there between for guiding a fluid to flow therein. In this way, the heat of the base 20 and the heat-dissipating member 23 can be radiated to the outside and heat-exchanged with the fluid flowing in the first heat-dissipating space 31.

The first heat-conducting portion 234 is formed by protruding axially from the edge of the first hole 231. One end of the first heat-conducting portion 234 abuts against the bottom of the base 20 to support the base 20. Further, the first heat-conducting portion 234 conducts the heat of the heat-conducting member 26 to the first heat-diffusing portion 233 for heat dissipation.

The assembling portion 25 has a fourth hole 251, a second heat-diffusing portion 253, a second heat-conducting portion 254 and a connecting end 255. The fourth hole 251 is located opposite to the third hole 231. The second heat-diffusing portion 253 is formed by extending outwardly from the fourth hole 251. The second heat-diffusing portion 253 and the heat-dissipating member 23 define a second heat-dissipating space 32 there between for guiding the fluid to flow therein. In this way, the heat of the heat-dissipating member 23 and the assembling portion 25 can be radiated to the outside and heat-exchanged with the fluid flowing in the second heat-dissipating space 32.

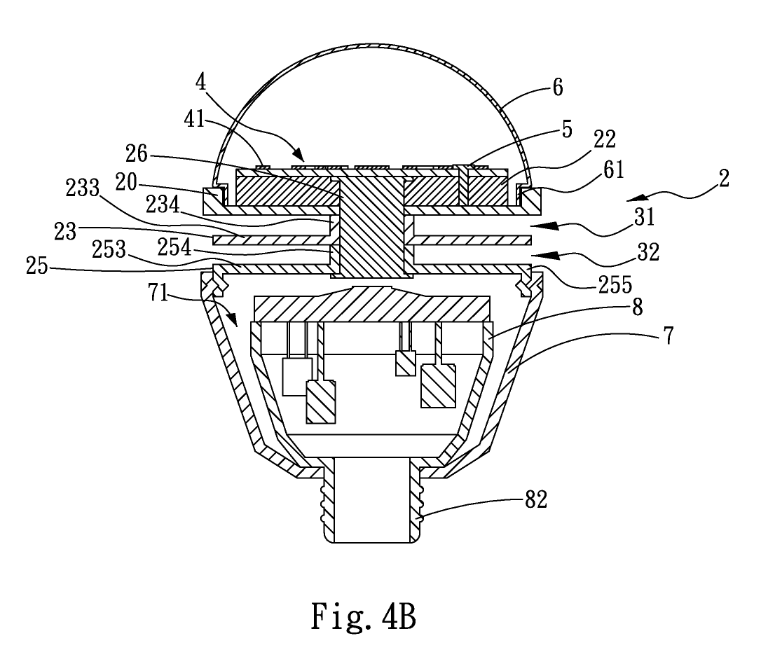

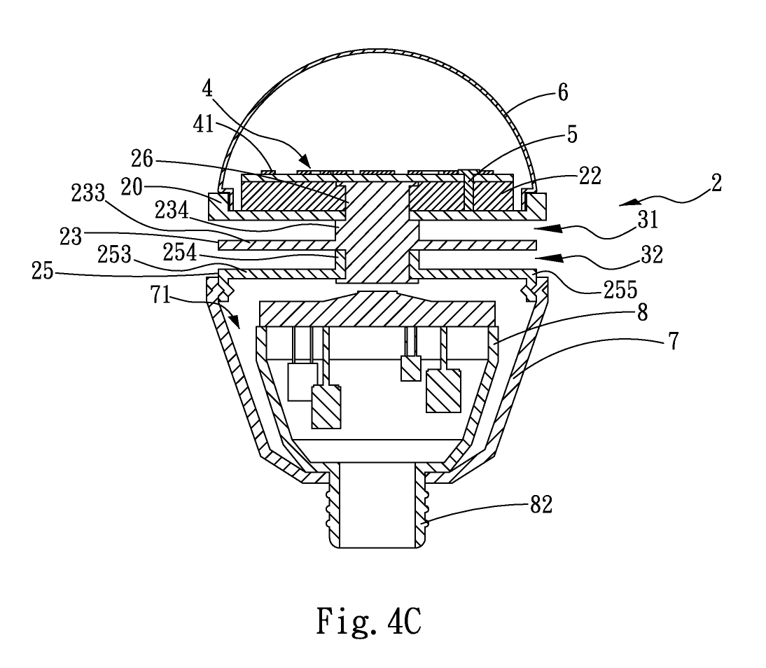

Please refer to FIG. 2A and also to FIGS. 2 and 4B. The second heat-conducting portion 254 is formed by protruding axially from the edge of the fourth hole 251. One end of the second heat-conducting portion 254 abuts against the bottom of the heat-dissipating member 23 to support the heat-dissipating member 23. Further, the second heat-conducting portion 254 conducts the heat of the heat-conducting member 26 to the second heat-diffusing portion 253 for heat dissipation. The connecting end 255 is formed by protruding from an outer end of the heat-diffusing portion 253 away from the base 20. That is, the second heat-conducting portion 254 and the connecting end 255 are formed on the assembling portion 25 with opposite protruding directions.

The heat-conducting member 26 is made of metallic materials such as copper, iron, aluminum or the like. The heat-conducting member 26 is disposed through the first hole 204, the second hole 221, the third hole 231, and the fourth hole 251 to be combined with the base 20, the heat-absorbing member 22, the heat-dissipating member 23 and the assembling portion 25, thereby constituting the heat-dissipating structure 2. The heat-conducting member 26 rapidly conducts the heat of the LED module 4 absorbed by the heat-absorbing member 22 to the base 20, the heat-absorbing member 22, the heat-dissipating member 23 and the assembling portion 25 for heat dissipation. The connection of the heat-conducting member 26 with the base 20, the heat-absorbing member 22, the heat-dissipating member 23 and the assembling portion 25 can be achieved by means of riveting, insertion, engagement, soldering, or interference fit. In the present embodiment, the heat-conducting member 26 is disposed through the first hole 204, the second hole 221, the third hole 231, and the fourth hole 251 to be combined with the base 20, the heat-absorbing member 22, the heat-dissipating member 23 and the assembling portion 25 by rivets, thereby forming one body. However, the present invention is not limited to the above specific form.

Furthermore, since the base 20, the heat-absorbing member 22, the heat-dissipating member 23, the assembling portion 25 and the heat-conducting member 26 are assembled together to form one body, the light-emitting efficiency of the LED bulb can be improved greatly and a better heat-dissipating effect can be achieved.

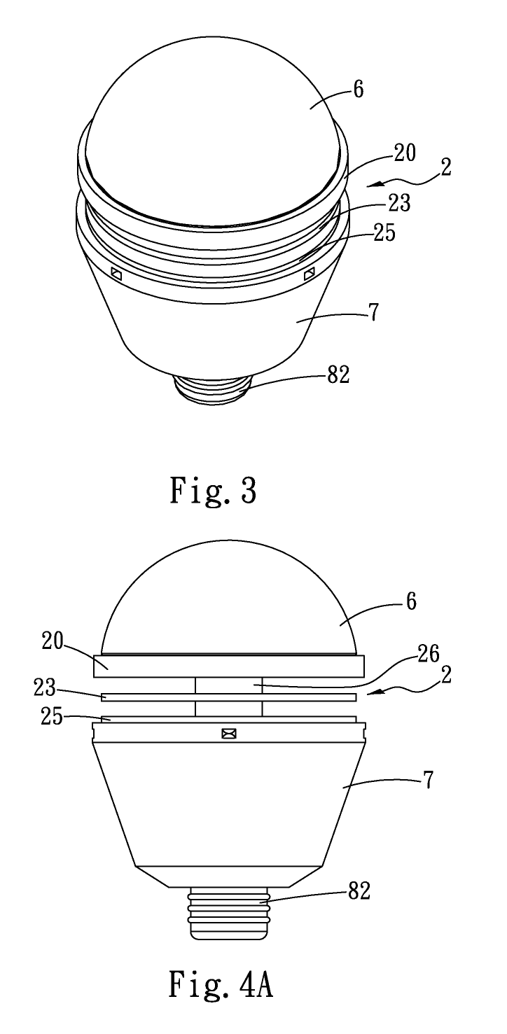

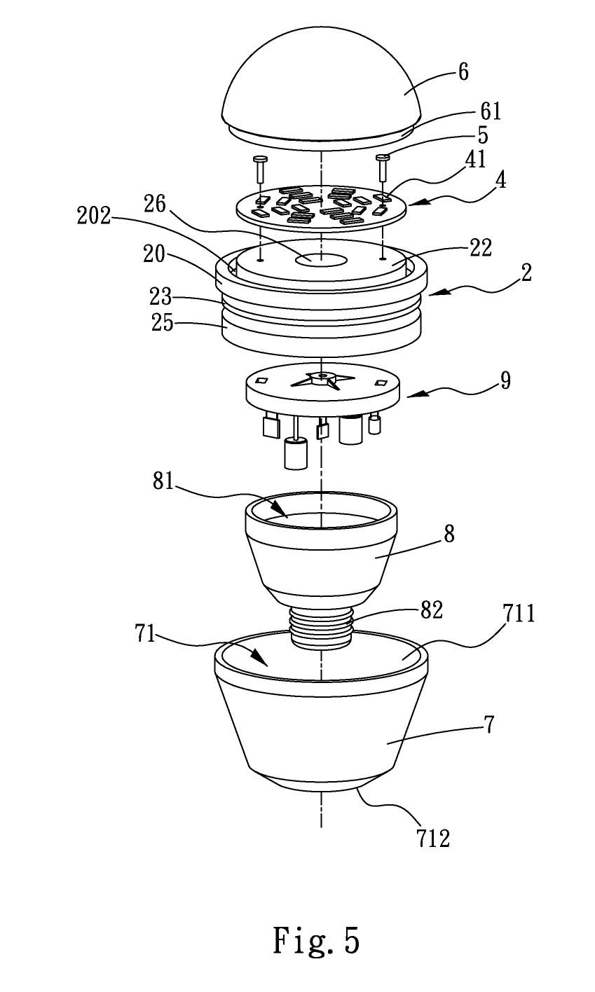

Please refer to FIGS. 3, 4A, 4B and 5. The heat-absorbing member 22 is connected to a LED module 4 having a plurality of LED chips 41. The LED chips 41 are arranged on one surface of the LED module 4 opposite to the heat-absorbing member 22. That is, one surface of the LED module 4 is adhered tightly to the heat-absorbing member 22, and the other surface thereof is formed thereon with the LED chips 41.

The LED module 4 is fixed to the heat-absorbing member 22 by means of at least one fixing member 5 (such as a screw). The base 20 supports a shroud 6 having an insertion portion 61. The insertion portion 61 is inserted into the trough 202 to cover the LED module 4 and the heat-absorbing member 22. That is, the shroud 6 moves toward the base 20 until the insertion portion 61 is inserted into the trough 202 and the shroud 6 covers the LED module 4 and the heat-absorbing member 22.

Further, the assembling portion 25 is connected to a housing 7 by means of an interference fit, denting, insertion, engagement, soldering or the like. In the present embodiment, the assembling portion 25 is connected to the housing 7 by a denting process. That is, the outer surface of the connecting end 255 of the assembling portion 25 abuts against the inner surface of the housing 7. Then, the outer surface of the housing 7 is dented toward the connecting end 255, thereby making the housing 7 to be combined with the assembling portion 25. The housing 7 has a hollow accommodating space 71. The accommodating space 71 is provided with a first open side 711 and a second open side 712 opposite to the first open side 711. The first open side 711 and the second open side 712 define the accommodating space 71.

A supporting member 8 is received in the accommodating space 71. The supporting member 8 has a receiving space 81 and an electrical connector 82. A control circuit 9 is received in the receiving space 81. The electrical connector 82 is formed by protruding away from the receiving space 81. The electrical connector 82 penetrates the first open side 711 toward the second open side 712 until the electrical connector 82 protrudes from the second open side 712 and the outer surface of the supporting member 8 abuts against the inner surface of the housing 7. Then, the electrical connector 82 is fixed to a lamp base of a lamp (not shown) by screws.

Thus, when the LED module 4 emits light, the LED module 4 and the LED chips 41 mounted thereon will generate a great amount of heat. The heat is absorbed by the heat-absorbing member 22 and conducted to the base 20 and the heat-conducting member 26. Then, a portion of the heat is radiated to the outside by means of the larger heat-dissipating area of the base 20. At the same time, the heat-conducting member 26 rapidly conducts the majority of the heat to the first heat-conducting portion 234 and the second heat-conducting portion 254, so that the first heat-conducting portion 234 and the second heat-conducting portion 254 conduct the heat to the first heat-diffusing portion 233 and the second heat-diffusing portion 253. The first heat-diffusing portion 233 and the second heat-diffusing portion 253 have a larger heat-diffusing area for radiating the heat to the outside. On the other hand, the base 20 and the first heat-diffusing portion 233 can be heat-exchanged with the fluid flowing in the first heat-dissipating space 31, while the base 20 and the second heat-diffusing portion 253 can be heat-exchanged with the fluid flowing in the second heat-dissipating space 32. In this way, the heat-dissipating area of the whole structure can be increased greatly to generate an excellent heat-dissipating effect. Furthermore, the light-emitting efficiency of the LED module 4 can be improved efficiently.

Please refer to FIGS. 2, 2B, 3, 4A, 4C and 5 showing the second embodiment of the present invention. The description relating to the construction, connection and effects of the second embodiment equal to those of the first embodiment is omitted for simplicity. The difference between the second embodiment and the first embodiment lies in that: the fourth hole 251 of the assembling portion 25 in the first embodiment is modified as a third hole 231, while the heat-dissipating member 23 is not provided with any hole. That is, in the second embodiment, the heat-dissipating member 23 is combined with the heat-conducting member 26, so that the heat-conducting member 26 is integrally formed on the heat-dissipating member 23. One end and the other end of the heat-conducting member 26 are disposed through the first hole 204 of the base 20, the second hole 221 of the heat-absorbing member 22 and the third hole 231 of the assembling portion 25, so that the assembling portion 25, the base 20 and the heat-absorbing member 22 are connected with each other. The connection of the heat-conducting member 26 with the base 20, the heat-absorbing member 22 and the assembling portion 25 may be achieved by insertion, engagement or soldering.

The heat-dissipating member 23 has a first heat-diffusing portion 233 and a first heat-conducting portion 234. The first heat-diffusing portion 233 is formed by extending outwards from the center of the heat-conducting member 26. The first heat-conducting portion 233 and the base 20 define a first heat-dissipating space 31 there between for guiding an external fluid to flow therein. Since the base 20 and the heat-dissipating member 23 have a larger heat-dissipating area, the heat of the base 20 and the heat-dissipating member 23 can be radiated to the outside and heat-exchanged with the fluid flowing in the first heat-dissipating space 31.

Further, the first heat-conducting portion 234 is formed by protruding axially from the heat-dissipating member 23 adjacent to the heat-conducting member 26. One end of the first heat-conducting portion 234 abuts against the bottom of the base 20 to support the base 20. The first heat-conducting portion further conducts the heat of the heat-conducting member 26 to the first heat-diffusing portion 233 for heat dissipation.

The assembling portion 25 has the third hole 231, the second heat-diffusing portion 253, the second heat-conducting portion 254 and the connecting end 255 protruding from the outer end of the second heat-diffusing portion 253 away from the base 20. The second heat-diffusing portion 253 is formed by extending outwardly from the third hole 231. The second diffusing portion 253 and the heat-dissipating member 23 define a second heat-dissipating space 32 for guiding a fluid to flow therein. Since the heat-dissipating member 23 and the assembling portion 25 have a larger heat-dissipating area, the heat of the heat-dissipating member 23 and the assembling portion 25 can be radiated to the outside and heat-exchanged with the fluid in the second heat-dissipating space 32.

The second heat-diffusing portion 254 is formed by protruding axially from the edge of the third hole 231. One end of the second heat-conducting portion 254 abuts against the bottom of the heat-dissipating member 23 to support the heat-dissipating member 23. The second heat-conducting portion 254 further conducts the heat of the heat-conducting portion 26 to the second heat-diffusing portion 253 for heat dissipation.

Please refer to FIGS. 3, 4A, 6A, 7 and 8 showing the third embodiment of the present invention. The description relating to the construction, connection and effects of the third embodiment equal to those of the first embodiment is omitted for simplicity. The difference between the third embodiment and the first embodiment lies in that: the heat-conducting member 26 in the first embodiment is modified to be replaced by a heat-conducting portion 223 of the heat-absorbing member 22 in the third embodiment. That is, the heat-dissipating structure 2 includes a base 20, a heat-absorbing member 22, a heat-dissipating member 23 and an assembling portion 25. The base 20 has a trough 202 for accommodating the heat-absorbing member 22. The trough 202 is provided with a first hole 204. The first hole 204 is formed in the center of the trough 202 in communication with the trough 202.

The heat-absorbing member 22 is provided in the trough 202 and has a second hole 221 and the heat-conducting portion 223. The heat-conducting portion 223 is formed by extending axially from the edge of the second hole 221 for guiding the heat of the LED module 4 absorbed by the heat-absorbing member 22 and for rapidly conducting the heat to the base 20, the heat-dissipating member 23 and the assembling portion 25 for heat dissipation. A hollow space 225 is defined in the heat-conducting portion 223. The hollow space 225 is in communication with the second hole 221 and the accommodating space 71. The hollow space 225 is configured to conduct a portion of the heat of the heat-conducting portion 223 and a portion of the heat generated by the LED chips 41 to the accommodating space 71. Then, the heat in the accommodating space 71 is radiated to the outside through the housing 7. The heat-dissipating structure 2 is made of metallic materials such as copper, iron, aluminum or the like.

The heat-dissipating member 23 has a third hole 231, a first heat-diffusing portion 233 and a first heat-conducting portion 234. The third hole 231 is located opposite to the first hole 204. The first heat-diffusing portion 233 is formed by extending outwardly from the third hole 231. The first heat-diffusing portion 233 and the base 20 define a first heat-dissipating space 31 there between for guiding a fluid to flow therein. The heat of the base 20 and the heat-dissipating member 23 is radiated to the outside and heat-exchanged with the fluid flowing in the first heat-dissipating space 31.

The first heat-conducting portion 234 is formed by protruding axially from the edge of the third hole 231. One end of the first heat-conducting portion 234 abuts against the bottom of the base 20 to support the base 20. Further, the first heat-conducting portion 234 conducts the heat of the heat-conducting portion 223 to the first heat-diffusing portion 233 for heat dissipation.

The assembling portion 25 has a fourth hole 251, a second heat-diffusing portion 253, a second heat-conducting portion 254 and a connecting end 255. The fourth hole 251 is located opposite to the third hole 231. The second heat-diffusing portion 253 is formed by extending outwardly from the fourth hole 251. The second heat-diffusing portion 253 and the heat-dissipating member 23 define a second heat-dissipating space 32 for guiding an external fluid to flow therein. In this way, the heat of the heat-dissipating member 23 and the assembling portion 25 can be radiated to the outside and heat-exchanged with the fluid flowing in the second heat-dissipating space 32.

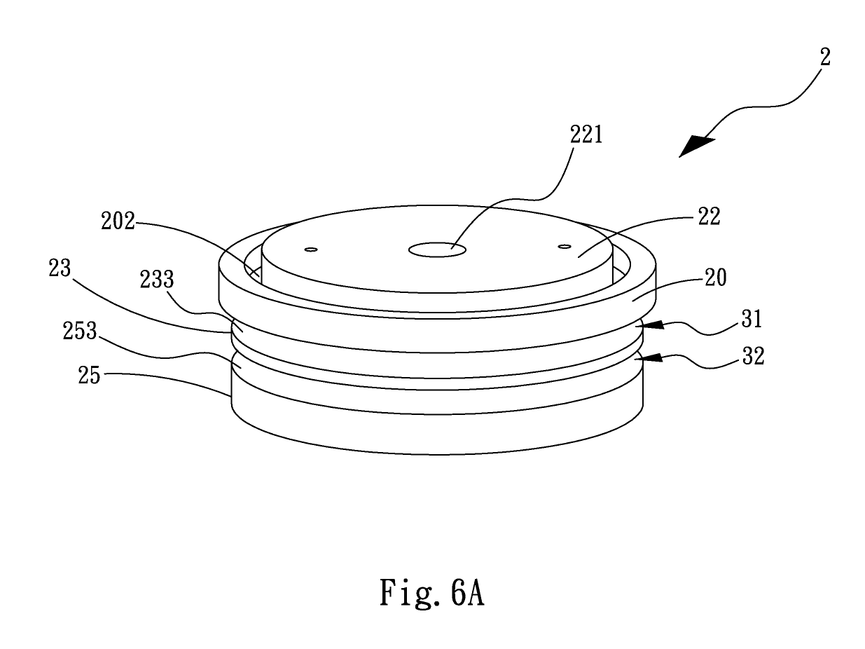

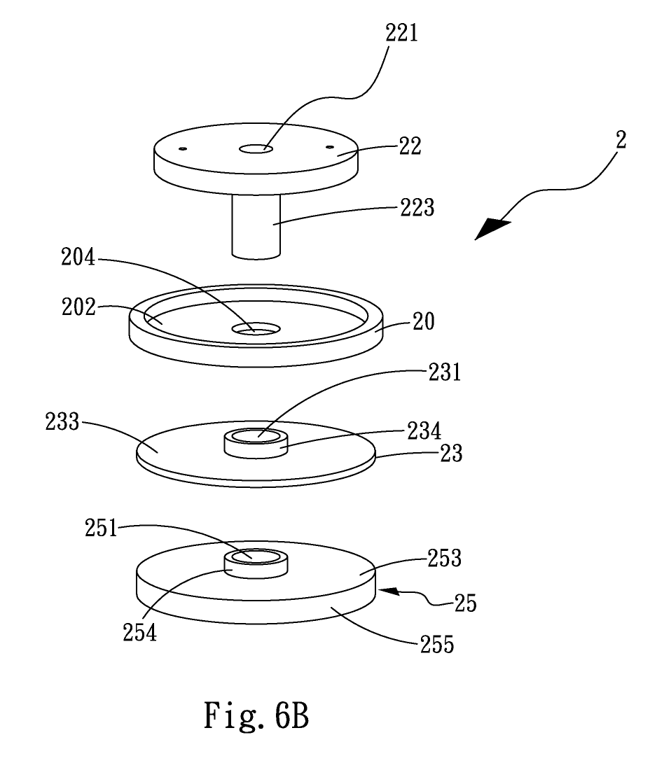

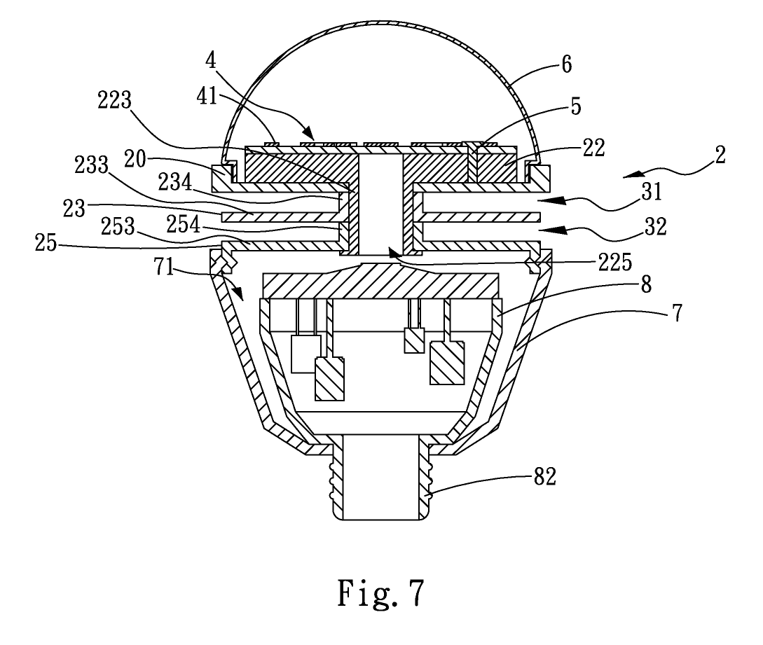

Please refer to FIG. 6B and also to FIGS. 6A and 7. The second heat-conducting portion 254 is formed by protruding axially from the edge of the fourth hole 251. One end of the second heat-conducting portion 254 abuts against the bottom of the heat-dissipating member 23 to support the heat-dissipating member 23. Further, the second heat-conducting portion 254 conducts the heat of the heat-conducting portion 223 to the second heat-diffusing portion 253 for heat dissipation. The connecting end 255 is formed by protruding from an outer end of the heat-diffusing portion 253 away from the base 20. That is, the second heat-conducting portion 254 and the connecting end 255 are formed on the assembling portion 25 with opposite protruding directions.

One end of the heat-conducting portion 223 is disposed through the first hole 204, the third hole 231 and the fourth hole 251 to be combined with the base 20, the heat-dissipating member 23 and the assembling portion 25, thereby constituting the heat-dissipating structure 2. The connection of the heat-conducting portion 223 with the base 20, the heat-dissipating member 23 and the assembling portion 25 may be achieved by means of interference fit, insertion, engagement or soldering. In the present embodiment, the heat-conducting portion 223 is disposed through the first hole 204, the third hole 231 and the fourth hole 251 to be combined with the base 20, the heat-absorbing member 22, the heat-dissipating member 23 and the assembling portion 25 by insertion (or interference fit), thereby forming one body. However, the present invention is not limited to the above specific form.

Furthermore, since the heat-conducting portion 223 of the heat-absorbing member 22, the base 20, the heat-dissipating member 23 and the assembling portion 25 are assembled together to form one body, the light-emitting efficiency of the LED bulb can be improved greatly and a better heat-dissipating effect can be achieved.

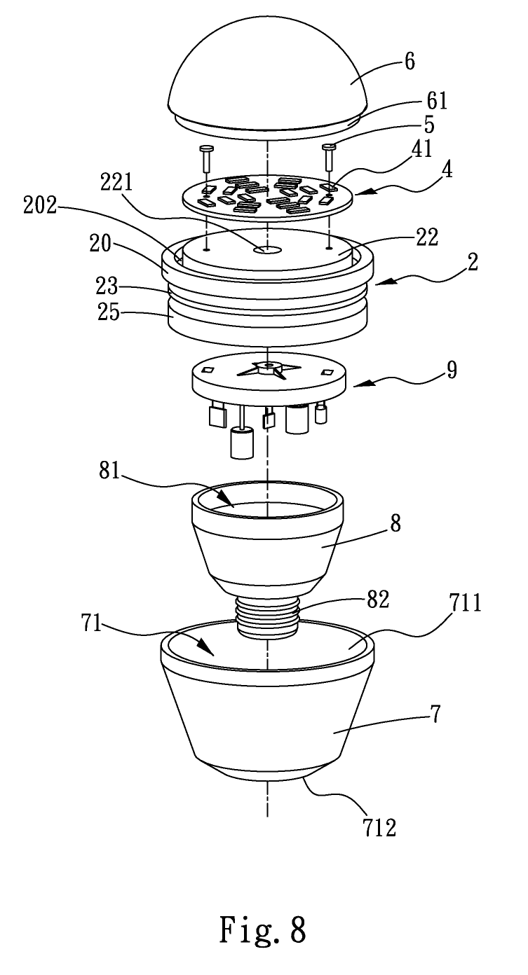

Please refer to FIGS. 7 and 8. When the LED module 4 emits light, the LED module 4 and the LED chips 41 mounted thereon will generate a great amount of heat. The heat is absorbed by the heat-absorbing member 22 and conducted to the base 20, the heat-dissipating member 23 and the assembling portion 25. Then, the heat-conducting portion 223 conducts a small portion of the heat generated by the LED chips 41 to the accommodating space 71 through the hollow space 225 and dissipated to the outside through the large heat-dissipating area of the housing 7.

A portion of the heat of the heat-conducting portion 223 is radiated to the outside through the base 20, while the other portion of the heat is rapidly conducted by the heat-conducting portion 223 to the first heat-conducting portion 234 and the second heat-conducting portion 254. Thus, the first heat-conducting portion 234 and the second heat-conducting portion 254 conduct the heat to the first heat-diffusing portion 233 and the second heat-diffusing portion 253 respectively. The first heat-diffusing portion 233 and the second heat-diffusing portion 253 have a larger heat-diffusing area for radiating the heat to the outside, so that the base 20 and the first heat-diffusing portion 233 can be heat-exchanged with the fluid flowing in the first heat-dissipating space 31 and heat-exchanged with the fluid flowing in the second heat-dissipating space 32 respectively. In this way, the heat-dissipating area of the whole structure can be increased greatly to generate an excellent heat-dissipating effect. Furthermore, the light-emitting efficiency of the LED module 4 can be improved efficiently.

According to the above, in comparison with the prior art, the present invention has the following advantageous effects of: (1) superior heat-dissipating effect; (2) increased heat-dissipating area; and (3) improved light-emitting efficiency of the LED module.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A heat-dissipating structure of a LED bulb, including:
a base having a trough and a first hole in communication with the trough;
a heat-absorbing member provided in the trough and having a second hole in communication with the first hole;
a heat-dissipating member having a third hole opposite to the first hole and a first heat-diffusing portion extending outwardly from the third hole, the first heat-diffusing portion and the base defining a first heat-dissipating space there between;
an assembling portion having a fourth hole and a second heat-diffusing portion extending outwardly from the fourth hole, the second heat-diffusing portion and the heat-dissipating member defining a second heat-dissipating space there between, a connecting end protruding from an outer end of the second heat-diffusing portion away from the base; and
a heat-conducting member disposed through the first, second, third and fourth holes to be combined with the base, the heat-absorbing member, the heat-dissipating member and the assembling portion.

2. The heat-dissipating structure of a LED bulb according to claim 1, wherein the heat-dissipating member further has a first heat-conducting portion protruding axially from an edge of the third hole, one end of the first heat-conducting portion abuts against the bottom of the base.

3. The heat-dissipating structure of a LED bulb according to claim 1, wherein the assembling portion has a second heat-conducting portion protruding axially from an edge of the fourth hole, one end of the second heat-conducting portion abuts against the bottom of the heat-dissipating member.

4. The heat-dissipating structure of a LED bulb according to claim 1, wherein the heat-absorbing member is connected to a LED module, one surface of the LED module is arranged with a plurality of LED chips.

5. The heat-dissipating structure of a LED bulb according to claim 4, wherein the base supports a shroud, the shroud has an insertion portion inserted into the trough to cover the LED module and the heat-absorbing member.

6. The heat-dissipating structure of a LED bulb according to claim 4, wherein the LED module is fixed to the heat-absorbing member through at least one fixing member.

7. The heat-dissipating structure of a LED bulb according to claim 1, wherein the assembling portion is connected to a housing, the housing has a hollow accommodating space, the accommodating space is provided with a first open side and a second open side opposite to the first open side.

8. The heat-dissipating structure of a LED bulb according to claim 7, wherein the accommodating space is received therein with a supporting member, the supporting member has a receiving space for allowing a control circuit to be disposed therein and an electrical connector protruding away from the receiving space, the supporting member is fixed to a lamp base by screws.

9. The heat-dissipating structure of a LED bulb according to claim 1, wherein the connection of the heat-conducting member with the base, the heat-absorbing member, the heat-dissipating member and the assembling portion is achieved by riveting, insertion, engagement or soldering.

10. A heat-dissipating structure of a LED bulb, including:
a base having a trough and a first hole in communication with the trough;
a heat-absorbing member provided in the trough and having a second hole in communication with the first hole;
a heat-dissipating member combined with a heat-conducting member, the heat-dissipating member having a first heat-diffusing portion extending outwardly from the center of the heat-conducting member, the first heat-diffusing portion and the base defining a first heat-dissipating space there between; and
an assembling portion having a third hole, a second heat-diffusing portion and a connecting end extending outwardly from the second heat-diffusing portion away from the base, the second heat-diffusing portion extending outwardly from the third hole, the second heat-diffusing portion and the heat-dissipating member defining a second heat-dissipating space there between, one end and another end of the heat-conducting member being disposed through the first, second and third holes to be combined with the assembling portion, the base and the heat-absorbing member.

11. The heat-dissipating structure of a LED bulb according to claim 10, wherein the heat-dissipating member further has a first heat-conducting portion protruding axially from the heat-dissipating member adjacent to the heat-conducting member, one end of the first heat-conducting portion abuts against the bottom of the base.

12. The heat-dissipating structure of a LED bulb according to claim 10, wherein the assembling portion has a second heat-conducting portion protruding axially from an edge of the third hole, one end of the second heat-conducting portion abuts against the bottom of the heat-dissipating member.

13. The heat-dissipating structure of a LED bulb according to claim 10, wherein the connection of the heat-conducting member with the base, the heat-absorbing member, and the assembling portion is achieved by insertion, engagement or soldering.

14. The heat-dissipating structure of a LED bulb according to claim 10, wherein the heat-conducting member is integrally formed on the heat-dissipating member.

15. A heat-dissipating structure of a LED bulb, including:
a base having a trough and a first hole in communication with the trough;
a heat-absorbing member provided in the trough and having a second hole and a heat-conducting portion extending axially from an edge of the second hole;
a heat-dissipating member having a third hole opposite to the first hole and a first heat-diffusing portion extending outwardly from the third hole, the first heat-diffusing portion and the base defining a first heat-dissipating space; and
an assembling portion having a fourth hole and a second heat-diffusing portion extending outwardly from the fourth hole, the second heat-diffusing portion and the heat-dissipating member defining a second heat-dissipating space there between, a connecting end protruding from an outer end of the second heat-diffusing portion away from the base, one end of the heat-conducting portion being disposed through the first, third and fourth hole to be combined with the base, the heat-dissipating member and the assembling portion.

16. The heat-dissipating structure of a LED bulb according to claim 15, wherein a hollow space is defined in the heat-conducting member in communication with the second hole.

17. The heat-dissipating structure of a LED bulb according to claim 15, wherein the heat-dissipating member further has a first heat-conducting portion protruding axially from an edge of the third hole, one end of the first heat-conducting portion abuts against the bottom of the base.

18. The heat-dissipating structure of a LED bulb according to claim 15, wherein the assembling portion has a second heat-conducting portion protruding axially from an edge of the fourth hole, one end of the second heat-conducting portion abuts against the bottom of the heat-dissipating member.

19. The heat-dissipating structure of a LED bulb according to claim 15, wherein the connection of the heat-conducting portion with the base, the heat-dissipating member and the assembling portion is achieved by interference fit, insertion, engagement or soldering.
